(19) United States
(12) Patent Application Publication
(10) Pub. No.: US 2017/0100906 A1
(43) Pub. Date: Apr. 13, 2017

(54) Paper Dunnage Apparatus

(71) Applicant: Lincoln Coders Corp., Fort Wayne, IN (US)

(72) Inventors: Matthew Beaver, Fort Wayne, IN (US); Luis DeVeyra, Fort Wayne, IN (US); Robert Beaver, Fort Wayne, IN (US)

(73) Assignee: LINCOLN CODERS CORP., Fort Wayne, IN (US)

(21) Appl. No.: 14/881,358

(22) Filed: Oct. 13, 2015

(51) Int. Cl. B31D 5/00

(52) U.S. Cl. CPC B31D 5/0052; B31D 2205/0023; B31D 2205/0058

(57) ABSTRACT

An apparatus for forming paper dunnage from rolled paper web includes a frame, a paper trough connected to the frame for supporting and retaining a paper roll, and a crumpling mechanism connected to the frame for drawing and receiving the paper web from the paper roll and crumpling the paper web to form paper dunnage. A paper guide is connected to the frame for receiving and guiding the paper web intermediate the paper trough and the crumpling mechanism. The paper guide is spring biased to maintain the paper web in tension between the paper roll and the crumpling mechanism. The paper guide can be a spring biased, pivotally mounted guide bar. Alternatively, the paper guide can be a cantilevered sheet of springy material having a free end that engages the paper web.

### BACKGROUND OF THE INVENTION

1. Field of the Invention

The present invention relates generally to apparatus for manipulating paper and, more particularly, to apparatus for unrolling a paper web from a paper roll and crumpling the paper to form dunnage for use in packing goods in shipping boxes or other containers.

2. Description of the Related Art

The related art includes various machines for making paper dunnage from rolled webs of paper.

U.S. Pat. No. 7,651,455, issued Jan. 26, 2010 to Yampolsky, shows a dunnage making machine in which a web of paper is drawn across a curved forming bar fixed to the frame of the machine, then drawn through a throat section to urge the edge portions toward each other and cause them to gather. Thereafter the gathered web of paper is drawn through a second throat section to further gather the paper. The gathered paper is then pressed with a roller to crumple it, following which the crumpled paper is perforated along a serrated tear line.

It would be desirable to provide a paper dunnage apparatus which is relatively inexpensive and which is capable of efficiently and relatively rapidly converting a paper web into dunnage. It would also be desirable to provide an improved apparatus for making paper dunnage having a reduced propensity to accidentally tear the paper web being drawn from the paper roll during use.

This and other desirable advantages are obtained by the present invention.

### SUMMARY OF THE INVENTION

In one form thereof, the present invention is directed to an apparatus for forming paper dunnage from rolled paper web, The apparatus includes a frame, and a paper trough connected to the frame for supporting and retaining a paper roll. A crumpling mechanism is connected to the frame for drawing and receiving the paper web from the paper roll and crumpling the paper web to form paper dunnage. A paper guide is connected to the frame for receiving and guiding the paper web intermediate the paper trough and the crumpling mechanism, the paper guide being spring biased to maintain the paper web in tension between the paper roll and the crumpling mechanism.

### BRIEF DESCRIPTION OF THE DRAWINGS

The above mentioned and other features and objects of this invention, and the manner of attaining them, will become more apparent and the invention itself will be better understood by reference to the following description of the embodiments of the invention taken in conjunction with the accompanying drawings, wherein:

FIG. 1 is a perspective view of an embodiment of an apparatus for making paper dunnage in accordance with the principles of the present invention;

FIG. 2 is another perspective view of the embodiment of FIG. 1;

FIG. 3 is a perspective view of the crumpling mechanism portion of the embodiment of FIG. 1, shown with the exit chute removed for clarity;

FIG. 4 is a perspective view similar to FIG. 1, shown with the paper web removed for clarity;

FIG. 5 is a side elevation view of the embodiment of FIG. 1, shown with the paper web removed for clarity;

FIG. 6 is a perspective view of another embodiment of an apparatus for making paper dunnage in accordance with the principles of the present invention;

FIG. 7 is another perspective view of the embodiment of FIG. 6, shown with the paper web removed for clarity;

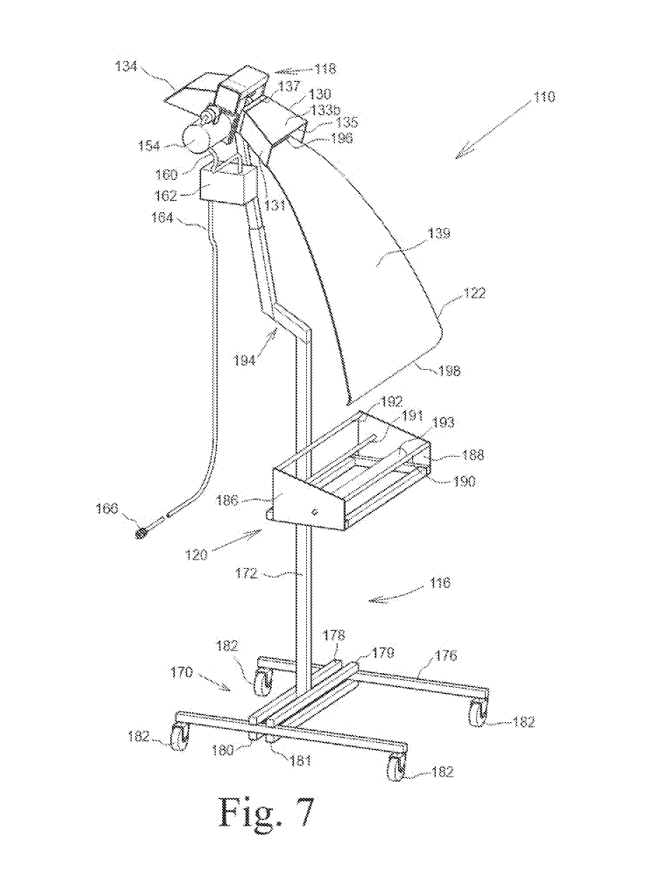

FIG. 8 is a perspective view of yet another embodiment of an apparatus for making paper dunnage in accordance with the principles of the present invention; and

FIG. 9 is a side elevation view of the embodiment of FIG. 8, shown with the paper web removed for clarity.

Corresponding reference characters indicate corresponding parts throughout several views. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION OF THE PREFERRED EMBODIMENTS

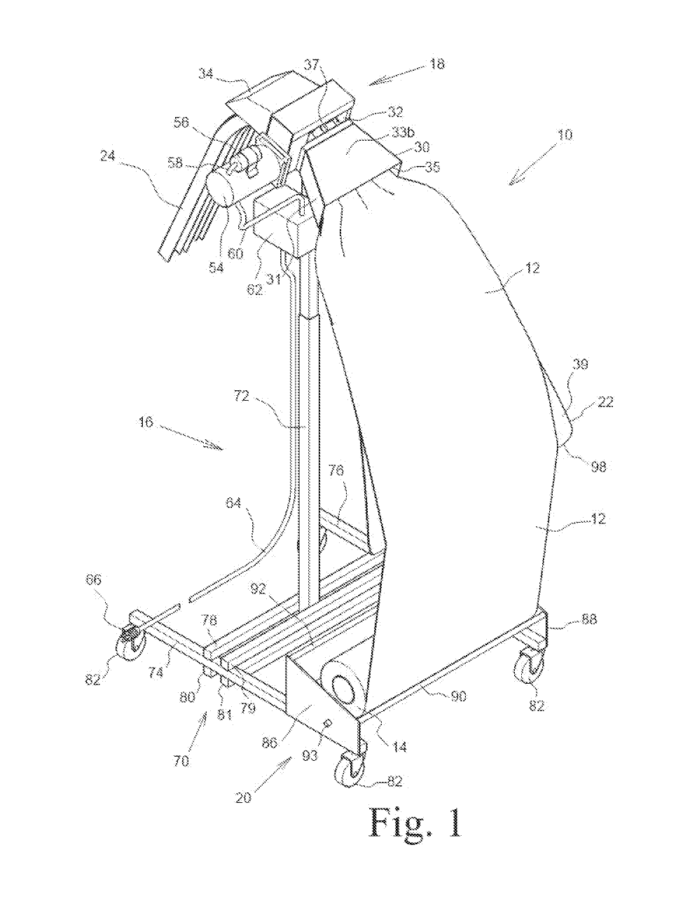

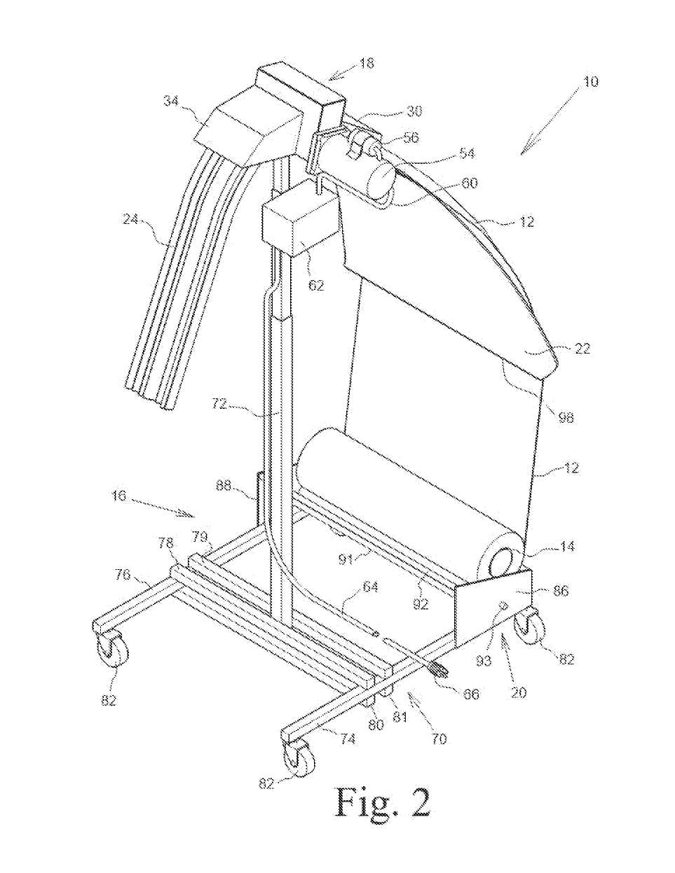

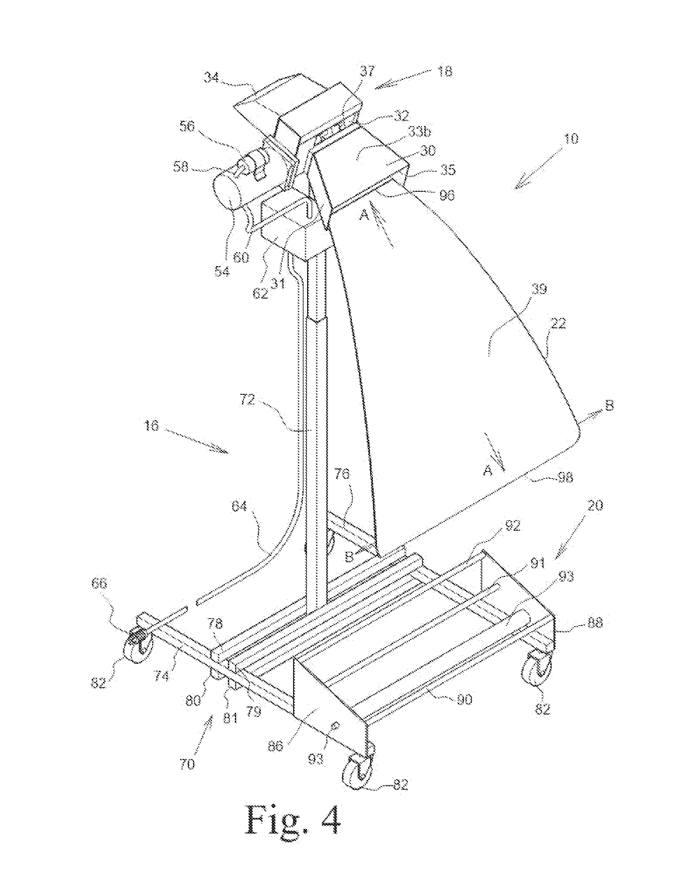

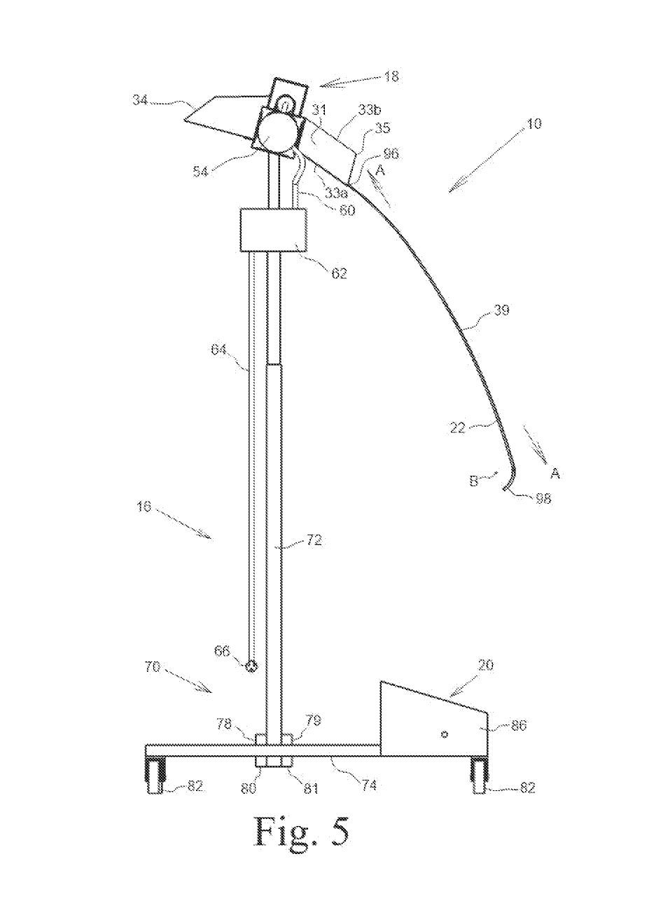

Referring to FIGS. 1-5, there is illustrated an example of one embodiment of the present invention in the form of an apparatus 10 for crumpling paper web 12 unrolled from a paper roll 14 for use as dunnage to fill space within a shipping box to cushion an article packed therein to protect it from damage during shipment. Apparatus 10 includes as principle components a frame 16 supporting a crumpling mechanism 18, a paper roll retaining trough 20, and a paper guide 22. In use, apparatus 10 draws paper web 12 from paper roll 14 up and over guide 22 and through crumpling mechanism 18. The crumpled paper web 24 exits crumpling mechanism 18 for use as dunnage. Guide 22 functions to guide the paper web 12 toward crumpling mechanism 18 and to maintain web 12 in tension and absorb excess tension as it is unrolled from paper roll 14 and drawn through crumpling mechanism 18.

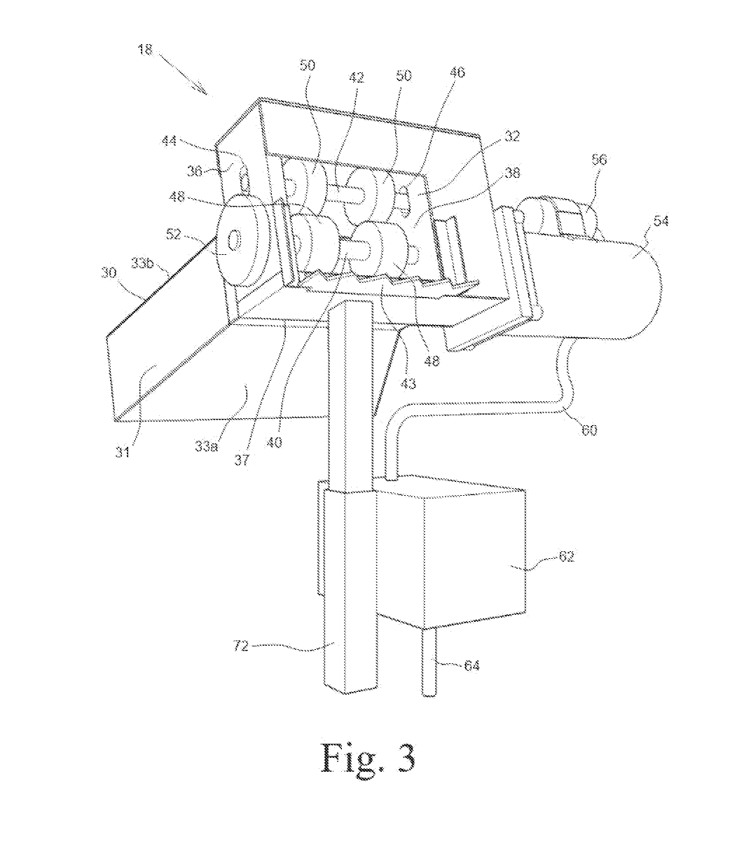

Crumpling mechanism 18 includes an entry funnel 30, a crumpling passageway 32 and an exit chute 34. Referring especially to FIG. 3, in which exit chute 34 has been removed for clarity, roller shafts 40 and 42 are shown. Disposed transversely within crumpling passageway 32 and supported by spaced walls 36 and 38, which define the lateral extents of crumpling passageway 32, roller shafts 40 and 42 are each mounted with appropriate bearings for rotation relative to support walls 36 and 38. Lower roller shaft 40 is mounted only for rotational motion, whereas upper roller shaft 42 is mounted for both rotation and for limited displacement away from lower roller shaft 40. Elongated slots 44 and 46 in support walls 36 and 38, respectively, accommodate linear movement of upper shaft 42 relative to lower shaft 40. Disposed below the exit opening of crumpling passageway 32 is a serrated or toothed cut off knife 43 that is useful for tearing off a desired length of paper dunnage 24 that has exited from between roller shafts 40 and 42. The operator can pull downwardly sharply on exiting paper dunnage 24, thereby tearing or cutting the paper free, with the remainder of the paper web remaining held between roller shafts 40 and 42.

Roller shaft 40 carries driven roller wheels 48 for rotation therewith. Roller shaft 42 carries pinch roller wheels 50 for rotation therewith. Roller wheels 48, 50 preferably are constructed of elastomeric rubber material that can deform somewhat under pressure, and have tread faces suitable for frictionally engaging the paper web 12 when pinched between the adjacent tread faces thereof. Roller shaft 42 is mounted under spring tension by springs (not shown) within crumpling mechanism 18 that bias shaft 42 toward shaft 40. Affixed to an outboard end of lower shaft 40 for rotation therewith, and disposed externally of crumpling mechanism 18, is a clutched hand wheel 52 for manually rotating roller shaft 40 to load paper web 12 into crumpling mechanism 18 prior to powered operation.

An electric gear motor 54 is connected to crumpling mechanism 18 and has an output shaft coupled to driven lower roller shaft 40. A starting capacitor 56 is connected to motor 54 via cable 58, and cable 60 connects motor 54 to motor controller 62, which is powered via power supply cable 64 and mains plug 66.

Frame 16 includes a base 70 rigidly supporting a substantially vertical column 72 atop which crumpling mechanism 18 is rigidly mounted. Base 70 is a weldment including a pair of spaced, substantially parallel rails 74 and 76 that are connected by transverse bars 78, 79, 80, 81 intermediate the free ends of rails 74 and 76. The lower end of column 72 is rigidly affixed to bars 78, 79, 80, 81 about midway between rails 74 and 76. Four casters 82 are attached to rails 74 and 76 proximate the respective free ends thereof, and mounted therebelow, to permit frame 16 to be rolled about on a floor surface for convenience of placement.

At one extreme end of base 70, mounted to rails 74, 76, is paper roll retaining trough 20. Spaced plates 86 and 88 comprise end walls for retaining paper roll 14 axially therebetween. Cross rods 90, 91, 92 are affixed at their respective ends to plates 86 and 88 to provide rigidity to trough 20 and to help retain paper roll 14 therewithin. A roller 93 extends between plates 86 and 88 and is mounted at its respective ends to plates 86, 88 in bearings to permit low friction rotation. Roller 93 is disposed so as to support most of the weight of paper roll 14, permitting paper web 12 to be unrolled therefrom with relatively little force. The outer surface of paper roll 14, in addition to bearing upon roller 93, may also occasionally bear against cross rod 90 or 91 as it is being unrolled. Friction between paper roll 14 and cross rods 90, 91 prevents paper roll 14 from unrolling freely due to inertia when the drawing of paper web 12 therefrom is stopped.

Entry funnel 30 includes a pair of spaced side walls 31, a bottom wall 33a and a top wall 33b arranged to form a trapezoidal funnel having an open rectangular intake end 35 and an open rectangular exit end 37 in communication with crumpling passageway 32 of crumpling mechanism 18. The rectangular opening of intake end 35 is wider horizontally than the rectangular opening of exit end 37, with side walls 31 converging from intake end 35 toward exit end 37. The opening of exit end 37 corresponds approximately to the width of the entrance of crumpling passageway 32.

Extending from proximate the bottom of entry funnel 30 is paper guide 22 comprising a sheet of springy material, preferably aluminum sheet, extending away from crumpling mechanism 18 generally in a direction toward paper trough 20, and hence paper roll 14. Paper guide 22 is generally shaped as an isosceles trapezoid, with the narrower end 96 connected to bottom wall 33a of entry funnel 30 at intake end 35 and having a width generally corresponding to the width of the entrance of entry funnel 30, although the width can be greater if desired. Paper guide 22 extends from end 96 at entry funnel 30 in cantilever fashion, generally in the direction of axis A, with the free, wider end 98 having a width somewhat wider than the width of the paper web 12 so that paper web 12 can feed smoothly from paper roll 14 onto guide 22 without catching on and being torn by the free corners of guide 22. Also to assist the smooth feeding of paper web 12, the extreme end of the wide free end 98 of guide sheet 22 is curved downwardly, parallel to free end 98 and about an axis B which is generally perpendicular to longitudinal axis A, in a relatively tight radius so that the paper web 12 feeds onto the free end of guide 22 generally tangentially to the tightly curved end surface.

At free end 98 of paper guide 22, paper web 12 lies flat against the upper surface 39 of paper guide 22, As paper web 12 is drawn toward crumpling mechanism 18, paper web 12 progressively gathers and folds upon itself in furrows lying generally in the direction of axis A, such that the side edges of paper web 12 move toward one another. At intake end 35, paper web 35 will have been folded, gathered and reduced in width such that it can be received in entry funnel 30 through intake end 35. Once within funnel 30, paper web 12 is further reduced in width by engagement with converging side walls 31 that cause further gathering and folding, resulting in paper web 12 being gathered to a width sufficiently narrow to enter crumpling passageway 32 and be frictionally engaged between the opposed driven and pinch rollers 48 and 50,.

Because of the isosceles trapezoidal shape of the paper guide 22, with the narrow end 96 proximate the crumpling mechanism 18 and the wide free end 98 cantilevered therefrom and located proximate the paper trough 20, any downward force applied at free end 98 tends to cause more deformation or curvature in paper guide 22 near the narrow end 96 and less deformation near the free end 98, such that the radius of curvature of paper guide 22 generally increases in the direction of axis A from cantilevered end 96 to proximate free end 98. Consequently, free end 98 can deflect downwardly over a relatively great range in response to changes in tension in paper web 12, such that under increasing tension the free end 98 of guide sheet 22 becomes disposed at an angle more nearly tangential to paper web 12, thereby absorbing intermittent variations in tension and reducing the likelihood of paper web 12 tearing. This effect is particularly advantageous by permitting rapid acceleration of paper web 12 into crumpling mechanism 18 upon activation of electric motor 54, whereby the inertia of paper roll 14 that resists rotational acceleration thereof is compensated for by the springy deflection of paper guide 22 and the relatively large range of displacement of free end 98 which absorbs some of the sudden increase in tension that would otherwise be induced in paper web 12, thereby avoiding exceeding the tear strength of paper web 12.

In operation, the electric motor 54 is selectively energized by motor controller 62 under suitable input from the operator, thereby pulling paper web 12 through the entry funnel 30 and between the driven roller wheels 48 and the pinch rollers 50. The sudden acceleration of paper web 12 via rollers 48 and 50, caused by turning on electric motor 54, tends to cause a sudden increase in the lengthwise tension of paper web 12, inasmuch as paper roll 14 cannot rotationally accelerate instantly. Paper guide 22 deforms as described above and the free end 98 is pulled downwardly as paper guide 22 deflects in cantilever fashion, resulting in the springiness of paper guide 22 absorbing much of the tension that would otherwise be induced in paper web 12, preventing the tearing of paper web 12 between paper roll 14 and entry funnel 30 upon the energization of electric motor 54.

Paper web 12 tends to deform, gather and fold upon itself with multiple loose creases as it is drawn into entry funnel 30 which has an opening width that is less than the width of the undeformed paper web 12. As paper web 12 is drawn further into the narrowing entry funnel 30, it becomes paper dunnage 24 that is increasingly folded and crumpled as its overall width decreases. Roller wheels 48 and 50 push the crumpled paper dunnage 24 out of crumpling passageway 32 and into exit chute 34 that is open at the bottom and guides the paper dunnage 24 outwardly and downwardly. The operator selectively stops the electric motor 54 when a desired length of paper dunnage has been pushed out and then rips the crumpled dunnage from the web by pulling it against the serrated knife edge 43.

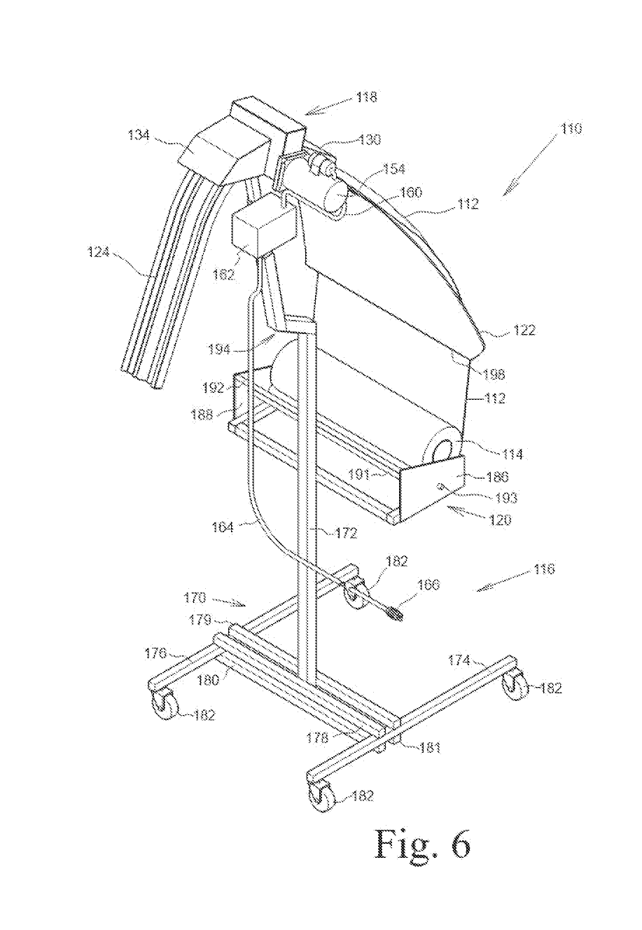

Referring to FIGS. 6 & 7, there is illustrated an example of another embodiment of the present invention in the form of an apparatus 110 for making crumpled paper dunnage. Except for the differences as described below, apparatus 110 is generally similar to the apparatus 10 of FIGS. 1-5 described above. Therefore, reference should be made to the above description of apparatus 10 for an understanding of corresponding parts of apparatus 110 that are not specifically described below. The above descriptions of apparatus 10 that are not inconsistent with the following description of apparatus 110 are incorporated by reference with respect to the description of apparatus 110. Corresponding parts are identified by like reference numerals in the 100 series, e.g., apparatus 110 corresponds to apparatus 10.

Apparatus 110 includes as principle components a frame 116 supporting a crumpling mechanism 118, a paper roll retaining trough 120, and a paper guide 122. In use, apparatus 110 draws paper web 112 from paper roll 114 up and over guide 122 and through crumpling mechanism 118. The crumpled paper web 124 exits crumpling mechanism 118 for use as dunnage. Guide 122 functions to guide the paper web 112 toward crumpling mechanism 118 and to maintain web 112 in tension and absorb excess tension as it is unrolled from paper roll 114 and drawn through crumpling mechanism 118.

The embodiment of apparatus 110 differs from apparatus 10 primarily in that the paper roll retaining trough 120 is elevated above the base 170 and is connected to a mid-portion of column 72 and supported thereby at approximately waist height of an operator. This arrangement ay be preferred in situations for ease of loading new paper rolls 114 where it is desired to handle the paper rolls at waist height, the operator thereby avoiding having to bend down to floor level.

As a consequence of the increased elevation of the paper retaining trough 120 relative to trough 20, column 172 is provided with a dog-leg offset 194 intermediate trough 120 and crumpling apparatus 118. Offset 194, and the sloped orientation of the upper region of column 172, serve to relocate crumpling apparatus 118 in a horizontal direction away from the tower region of column 172 to accommodate the horizontal relocation of paper trough 120 from the extreme rear of base 170 to a mid-region thereof proximate column 172. This relocation is made to maintain the relative horizontal spacing of paper roll 114 and free end 198 of paper guide 122 generally similar to the relative horizontal spacing of paper roll 14 and free end 98 of paper guide 12. Consequently, paper guide 122 functions generally similarly to paper guide 22 in interaction with respective paper webs 112 and 12.

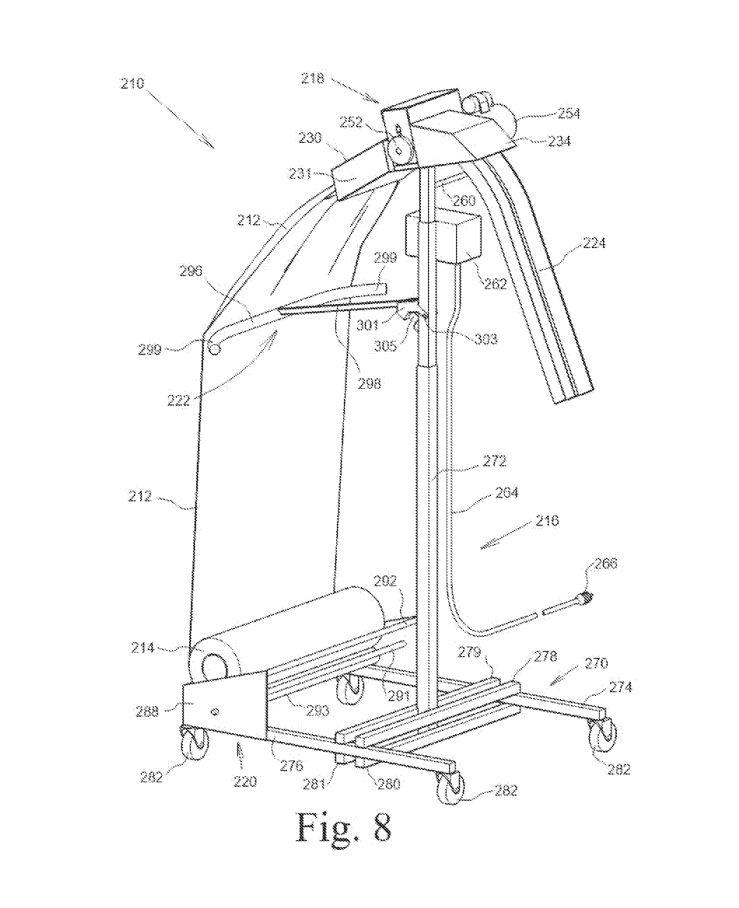

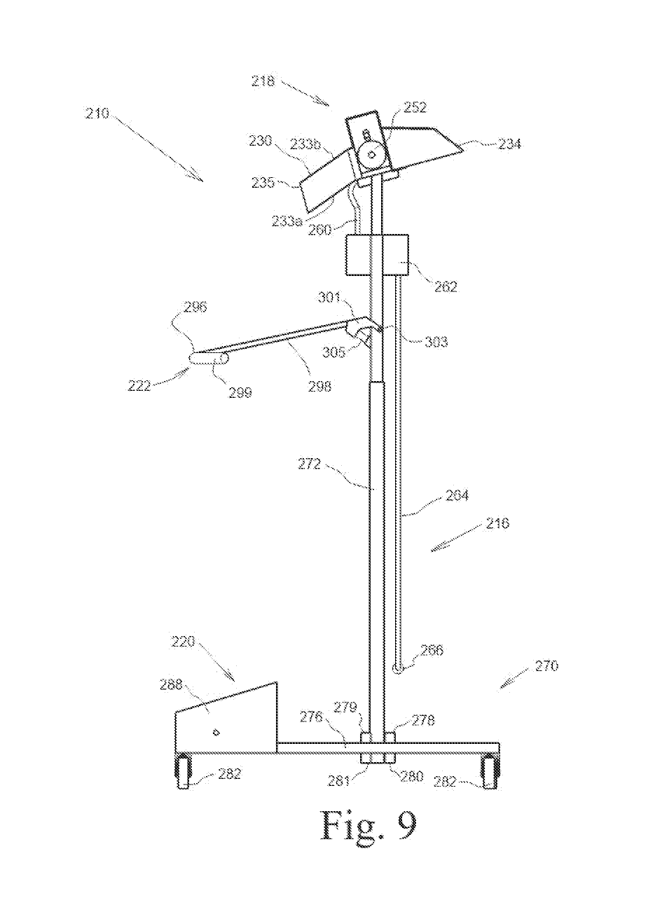

Referring to FIGS. 8 and 9, there is illustrated an example of yet another embodiment of the present invention in the form of an apparatus 210 for making crumpled paper dunnage. Except for the differences as described below, apparatus 210 is generally similar to the apparatus 10 of FIGS. 1-5 described above. Therefore, reference should be made to the above description of apparatus 10 for an understanding of corresponding parts of apparatus 210 that are not specifically described below. The above descriptions of apparatus 10 that are not inconsistent with the presently described apparatus 210 are incorporated by reference with respect to this description of apparatus 210. Corresponding parts are identified by like reference numerals in the 200 series, i.e., apparatus 210 corresponds to apparatus 10.

Apparatus 210 includes as principle components a frame 216 supporting a crumpling mechanism 218, a paper roll retaining trough 220, and a paper guide 222. In use, apparatus 210 draws paper web 212 from paper roll 214 up and over guide 222 and through crumpling mechanism 218. The crumpled paper web 224 exits crumpling mechanism 218 for use as dunnage. Guide 222 functions to guide the paper web 212 toward crumpling mechanism 218 and to maintain web 212 in tension and absorb excess tension as it is unrolled from paper roll 214 and drawn through crumpling mechanism 218.

The embodiment of apparatus 210 differs from apparatus 10 primarily in that instead of a cantilevered trapezoidal springy sheet serving as paper guide 22, a transverse guide bar 296 pivotally connected to column 272 by way of pivot arm 298 serves as paper guide 222. Guide bar 296 is of round cross-section to present a smoothly curved surface to contact paper web 212. Only the portion of the surface that engages paper web 212 need be smooth a d curved. The reverse surface can be any functional configuration. The bar ends 299 of guide bar 296 curve away from paper web 212 in a generally horizontal direction and toward column 272. The free ends of bar ends 299 extend transversely beyond the edges of paper web 212. The extent of the free ends outboard the paper web 212 and the curvature of the bar ends 299 away from paper web 212 ensure that the paper web rides centered on guide bar 296 and is protected from contacting and being torn by the recessed free ends.

Pivot arm 298 is fixed at one end to approximately the mid-point of guide bar 296 and extends generally perpendicular therefrom toward column 272. The other end of pivot a 298 is affixed to a yoke 301 that is pivotally attached to column 272 by way of pivot pin 303. compression coil spring 305 disposed between yoke 301 and column 27 biases pivot arm 298 and guide bar 296 in an upward direction to guide and maintain paper web 212 in tension as it is drawn into crumpling mechanism 218.

While this invention has been described as having an exemplary design, the present invention may be further modified within the spirit and scope of this disclosure. This application is therefore intended to cover any variations, uses, or adaptations of the invention using its general principles.

What is claimed is:

1. An apparatus for forming paper dunnage from rolled paper web, comprising:
a frame;
a paper trough connected to said frame for supporting and retaining a paper roll;
a crumpling mechanism connected to said frame for drawing and receiving said paper web from said paper roll and crumpling said paper web to form paper dunnage; and
a paper guide connected to said frame for receiving and guiding the paper web intermediate said paper trough and said crumpling mechanism, said paper guide being spring biased to maintain said paper web in tension between the paper roll and said crumpling mechanism.

2. The apparatus of claim 1, in which said paper guide includes a transverse guide bar.

3. The apparatus of claim 2, in which the guide bar is pivotally connected to said frame.

4. The apparatus of claim 1, in which said paper guide includes a sheet of springy material cantilevered relative to said frame.

5. The apparatus of claim 4, in which the sheet includes a free end that engages the paper web.

6. The apparatus of claim 5, in which the sheet has a greater width at the free end than at the cantilever end.

7. The apparatus of claim 6, in which the springy material of the sheet is sheet metal.

8. The apparatus of claim 7, in which the sheet metal includes aluminum material.

9. The apparatus of claim 6, in which the free end is radiused for smoothly engaging the paper web.

10. The apparatus of claim 9, in which the free end is curved with a smaller radius of curvature than the remainder of the sheet.

11. The apparatus of claim 1, further including an entry cone in communication with said crumpling mechanism for receiving the paper web.

12. The apparatus of claim 11, in which the entry cone has side walls that converge in a direction toward said crumpling mechanism,

13. The apparatus of claim 12, in which said paper guide includes a sheet of springy material cantilevered relative to said frame and extending from said entry cone.

14. The apparatus of claim 13, in which the sheet includes a free end that engages the paper web.

15. The apparatus of claim 14, in which the sheet has a greater width at the free end than at the cantilever end.

16. The apparatus of claim 15, in which the free end is radiused for smoothly engaging the paper web.

17. The apparatus of claim 16, in which the free end is curved with a smaller radius of curvature than the remainder of the sheet.

18. The apparatus of claim 15, in which the sheet has a radius of curvature that decreases along the longitudinal axis of the sheet toward the cantilever end.

19. The apparatus of claim 18, in which the free end is radiused for smoothly engaging the paper web.

20. The apparatus of claim 19, in which the springy material of the sheet is sheet metal.
